(19) United States
(12) Patent Application Publication
(10) Pub. No.: US 2025/0319706 A1
(43) Pub. Date: Oct. 16, 2025

(54) IMAGE PROCESSING METHOD, IMAGE FORMING APPARATUS

(71) Applicant: KYOCERA Document Solutions Inc., Osaka (JP)

(72) Inventors: Ryo Shiomi, Osaka (JP); Hiroshi Yokota, Osaka (JP)

(21) Appl. No.: 19/085,205

(22) Filed: Mar. 20, 2025

(30) Foreign Application Priority Data
Apr. 16, 2024 (JP) 2024-066219

(51) Int. Cl. B41J 11/00; G06F 3/12

(52) U.S. Cl. CPC B41J 11/0095; B41J 11/007; G06F 3/121; G06F 3/1254

(57) ABSTRACT

A line sensor is arranged at a specific position along a conveying belt. The processor processes a plurality of line image data sequentially obtained by the line sensor. The processor determines whether or not each of the plurality of line image data is unique data that includes a plurality of unique pixel values, which are pixel values outside an allowable range, and a number of the plurality of unique pixel values exceeds a reference pixel number. The processor detects that a sheet has reached the specific position when a number of consecutive unique data in the plurality of line image data reaches a reference consecutive number.

### INCORPORATION BY REFERENCE

This application is based upon and claims the benefit of priority from the corresponding Japanese Patent Application No. 2024-066219 filed on Apr. 16, 2024, the entire contents of which are incorporated herein by reference.

### BACKGROUND

The present disclosure relates to an image processing method and an image forming apparatus for processing data obtained by a line sensor regarding a state of a conveying belt that conveys a sheet.

An image forming apparatus may include a belt conveying device that conveys a sheet by a rotating conveying belt, and a printing device that forms an image on the sheet conveyed by the conveying belt. For example, the printing device forms an image on a sheet using an inkjet method.

In the image forming apparatus, a sensor for detecting the sheet is arranged at a specific position along the conveying belt. The result of detection of the sheet by the sensor is used to control timing for starting image formation by the printing device.

For example, a reflective optical sensor may be arranged opposite the conveying belt. A control portion is known that determines the presence or absence of the sheet on the conveying belt and a defect in the conveying belt depending on a detection level of reflected light by the reflective optical sensor.

### SUMMARY

An image processing method according to one aspect of the present disclosure is a method for processing a plurality of line image data obtained sequentially by a line sensor arranged along a second direction crossing a first direction at a specific position along a conveying belt capable of conveying a sheet along the first direction by rotating. The image processing method includes a processor determining whether or not each of the plurality of line image data is unique data including a plurality of unique pixel values that are pixel values outside an allowable range and a number of the plurality of unique pixel values exceeds a reference pixel number. Furthermore, the image processing method includes the processor detecting that the sheet has reached the specific position when a number of consecutive unique data in the plurality of line image data reaches a reference consecutive number.

An image processing method according to another aspect of the present disclosure is a method for processing a plurality of line image data obtained sequentially by a line sensor arranged along a second direction crossing a first direction at a specific position along a conveying belt capable of conveying a sheet along the first direction by rotating. The image processing method includes a processor determining whether or not each of the plurality of line image data is unique data including a plurality of unique pixel values that are pixel values outside an allowable range and a number of the plurality of unique pixel values exceeds a reference pixel number. Furthermore, the image processing method includes the processor determining a degree of abnormality of the conveying belt according to a number of the consecutive unique data in the plurality of line image data.

An image forming apparatus according to another aspect of the present disclosure includes a conveying belt, a line sensor, a printing device, and the processor that implements the image processing method. The conveying belt is capable of conveying a sheet along a first direction by rotating. The line sensor is arranged along a second direction crossing the first direction at a specific position along the conveying belt. The printing device forms an image on the sheet conveyed by the conveying belt.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a diagram showing a configuration of an image forming apparatus according to an embodiment.

FIG. 2 is a block diagram showing a configuration of a control device in an image forming apparatus according to an embodiment.

FIG. 3 is a plan view of a vicinity of a sheet entrance portion onto a conveying belt in an image forming apparatus according to an embodiment.

FIG. 4 is a flowchart showing an example of a procedure for a belt abnormality determining process in an image forming apparatus according to an embodiment.

FIG. 5 is a flowchart showing an example of a procedure of a sheet detection process in an image forming apparatus according to an embodiment.

FIG. 6 is a diagram schematically showing a plurality of line image data obtained in an image forming apparatus according to an embodiment.

### DETAILED DESCRIPTION

Hereinafter, embodiments of a technique according to the present disclosure will be described with reference to the drawings. Note that the following embodiments are examples of the technique according to the present disclosure and do not limit the technical scope of the present disclosure.

### [Configuration of Image Forming Apparatus 10]

An image forming apparatus 10 according to an embodiment includes a sheet storing portion 1, a sheet conveying device 3, and a printing device 4. Furthermore, the image forming apparatus 10 includes a drying device 5, an operation device 801, a display device 802, a control device 8, and the like.

The sheet conveying device 3 includes a sheet feeding mechanism 30, a plurality of sets of conveying roller pairs 31, a first belt conveying device 32, a second belt conveying device 33, and a discharge roller pair 34.

The sheet feeding mechanism 30 feeds a sheet 9 in the sheet storing portion 1 to a first conveying path 301. The plurality of sets of conveying roller pairs 31 convey the sheet 9 along the first conveying path 301, and further send the sheet 9 from the first conveying path 301 to the first belt conveying device 32.

The first belt conveying device 32 takes over from the plurality of sets of conveying roller pairs 31 to convey the sheet 9, and sends the sheet 9 to the second belt conveying device 33. The first belt conveying device 32 includes a circular conveying belt 320, a plurality of support rollers 321, and a suction device 322.

The plurality of support rollers 321 rotatably support the conveying belt 320. A belt drive motor (not shown) rotates one of the plurality of support rollers 321, thereby rotating the conveying belt 320.

The plurality of sets of conveying roller pairs 31 convey the sheet 9 onto an upper surface of the conveying belt 320. The sheet feeding mechanism 30 and the plurality of sets of conveying roller pairs 31 are an example of a front-stage conveying mechanism that is arranged on an upstream side of the conveying belt 320 in a sheet conveying direction FD1.

The rotating conveying belt 320 further conveys the sheet 9 that has been conveyed onto the upper surface thereof. The suction device 322 causes the sheet 9 to adhere to the upper surface of the conveying belt 320 by suction of air.

The second belt conveying device 33 takes over from the first belt conveying device 32 to convey the sheet 9, and further sends the sheet 9 to a second conveying path 302.

The discharge roller pair 34 conveys the sheet 9 along the second conveying path 302, and then sends the sheet 9 from the second conveying path 302 to a rear stage. For example, the rear stage is a discharge tray or a post-processing device.

The printing device 4 executes a printing process on the sheet 9 conveyed by the conveying belt 320 of the first belt conveying device 32. The printing process is a process for forming an image on the sheet 9.

In the present embodiment, the printing device 4 executes the printing process by an inkjet method. That is, the printing device 4 forms an image on the sheet 9 by ejecting ink onto the sheet 9. The ink is an example of a developing agent.

The printing device 4 includes a plurality of ink heads 41 and a plurality of ink supply portions 42, each of which corresponds to a different color of ink. More specifically, the printing device 4 has four ink heads 41 and four ink supply portions 42 corresponding to yellow, magenta, cyan and black.

Each of the ink heads 41 has a plurality of ejection nozzles 41a for ejecting ink. The ink heads 41 are fixed at positions facing the surface of the conveying belt 320 of the first belt conveying device 32. The plurality of ink supply portions 42 each accommodate a different color ink and supply the ink to the plurality of ink heads 41.

The drying device 5 dries an ink image on the sheet 9 by blowing hot air onto the sheet 9 being conveyed by the second belt conveying device 33.

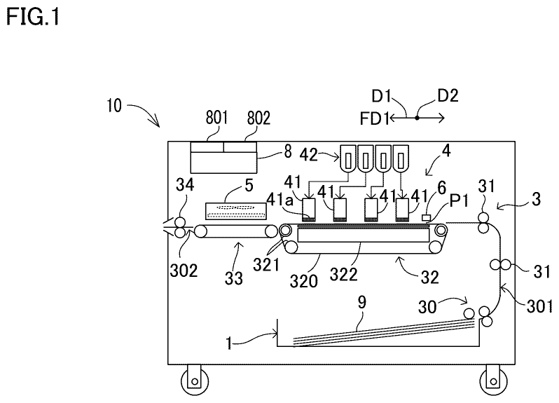

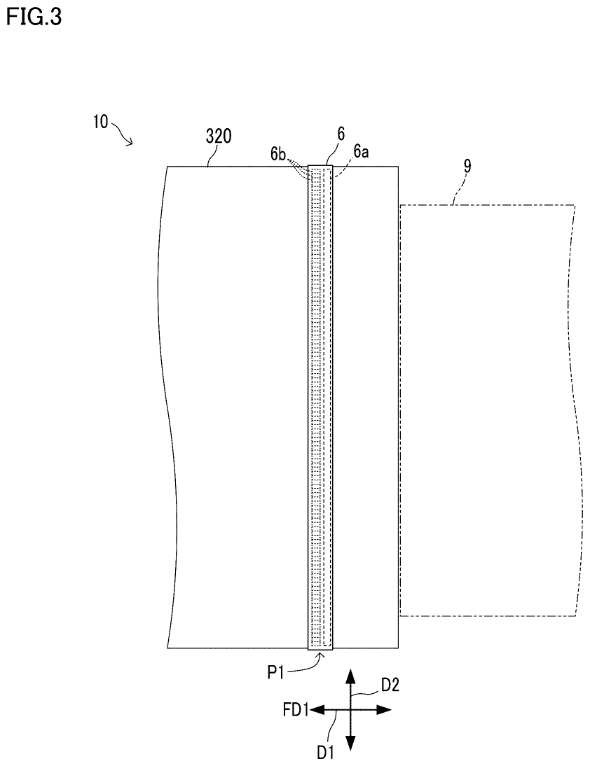

In FIGS. 1 and 3, a first direction D1 is a direction along the sheet conveying direction FD1 in the first belt conveying device 32. The sheet conveying direction FD1 is a direction in which the sheet 9 is conveyed by the first belt conveying device 32.

In FIGS. 1 and 3, a second direction D2 is a direction crossing the first direction D1. In the present embodiment, the second direction D2 is a direction perpendicular to the first direction D1. The second direction D2 is a main scanning direction in the printing process, and the first direction D1 is a sub-scanning direction in the printing process.

The operation device 801 detects operations by a person. For example, the operation device 801 includes a plurality of operation buttons and a touch panel. The display device 802 is capable of displaying various types of information. For example, the display device 802 is a panel display device such as a liquid crystal display panel.

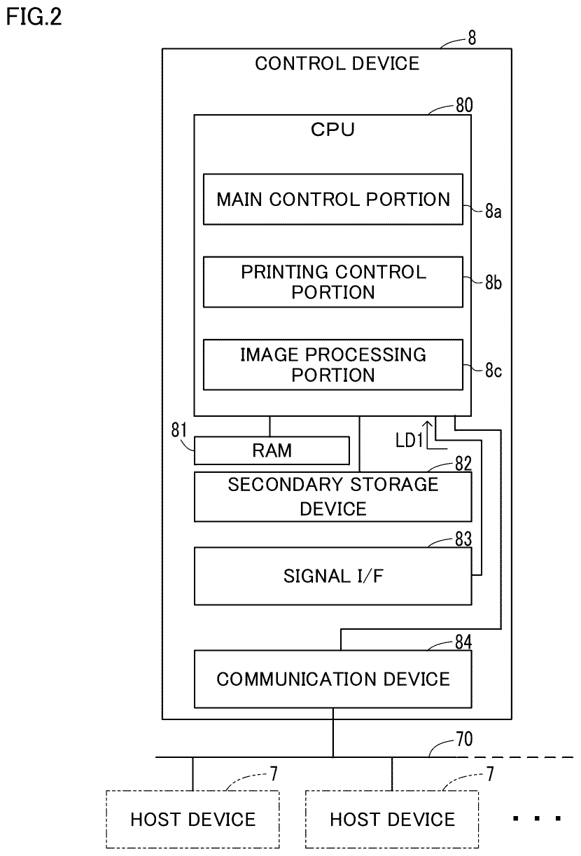

As shown in FIG. 2, the control device 8 includes a central processing unit (CPU) 80, a random access memory (RAM) 81, a secondary storage device 82, a signal interface 83, a communication device 84, and the like.

The CPU 80 executes various types of controls and data processing by executing computer programs. The RAM 81 temporarily stores the computer programs executed by the CPU 80 and various types of data.

The secondary storage device 82 is a computer-readable non-volatile storage device. The secondary storage device 82 stores the computer programs executed by the CPU 80 and various types of data. For example, one or both of a flash memory and a hard disk drive may be employed as the secondary storage device 82.

The signal interface 83 converts detection signals of various types of sensors into digital detection data, and transmits the detection data to the CPU 80. Furthermore, the signal interface 83 converts a control command output from the CPU 80 into a control signal, and transmits the control signal to a device to be controlled.

The communication device 84 executes communication with other devices such as a host device 7 via a network 70. The CPU 80 executes communication with other devices via the communication device 84. The host device 7 is an information processing device that requests the image forming apparatus 10 to perform the printing process.

The CPU 80 includes a plurality of processing modules that are implemented by executing the computer programs. The plurality of processing modules include a main control portion 8a and a printing control portion 8b (see FIG. 2).

The main control portion 8a executes control such as start control for starting various types of processes in response to an operation on the operation device 801 or a processing request received via the communication device 84.

The printing control portion 8b controls the sheet conveying device 3 and the printing device 4. The printing control portion 8b controls the sheet conveying device 3 to control conveying of the sheet 9.

Furthermore, the printing control portion 8b causes the printing device 4 to execute the printing process in synchronization with the conveying of the sheet 9. In addition, the printing control portion 8b operates the drying device 5 when the printing process is executed for the image to be printed.

The image forming apparatus 10 further includes a line sensor 6 arranged along the second direction D2 at a specific position P1 along the conveying belt 320 of the first belt conveying device 32 (see FIGS. 1 and 3). The specific position P1 is a position on the upstream side of the plurality of ink heads 41 of the printing device 4 in the sheet conveying direction FD1.

The line sensor 6 is an image sensor that reads an image of an area along the second direction D2 at the specific position P1.

The line sensor 6 includes a light emitting portion 6a and a plurality of photoelectric conversion elements 6b (see FIG. 3). The light emitting portion 6a irradiates light onto a band-shaped region on the surface of the conveying belt 320 along the second direction D2. The plurality of photoelectric conversion elements 6b are arranged in the second direction D2.

The plurality of photoelectric conversion elements 6b each detect an amount of diffusely reflected light on the surface of the conveying belt 320, and output a plurality of pixel signals each representing the detected amount of light. The plurality of pixel signals are converted into a plurality of pixel data by the signal interface 83, and the plurality of pixel data are transmitted to the CPU 80 as line image data LD1 (see FIG. 2).

That is, the line image data LD1 is the plurality of pixel data obtained by the operation of the line sensor 6. The line image data LD1 is used to detect the sheet 9 reaching the specific position P1.

In the present embodiment, the plurality of processing modules include an image processing portion 8c that processes line image data LD1. The image processing portion 8c detects the sheet 9 that has reached the specific position P1 by processing the line image data LD1. The detection result of the sheet 9 by the image processing portion 8c is used to control timing at which the printing device 4 starts forming an image.

There are cases in which light reflection characteristics of scratches or stains on the surface of the conveying belt 320 are similar to the light reflection characteristics of the sheet 9 on the conveying belt 320. In this case, scratches or stains on the surface of the conveying belt 320 may be erroneously detected as the sheet 9.

In the present embodiment, the image processing portion 8c executes a belt abnormality determining process and a sheet detection process, which will be described later. The abnormality determining process and the sheet detection process include a process for distinguishing and detecting scratches or stains on the surface of the conveying belt 320 from the sheet 9 on the conveying belt 320.

The abnormality determining process and the sheet detection process are examples of a process that achieves an image processing method for processing a plurality of line image data LD1 sequentially obtained by the line sensor 6.

Note that some or all of the processing executed by the CPU 80 may be executed by a digital signal processor (DSP) or a system on a chip (SoC), for example. The CPU 80, the DSP, or the SoC that executes the abnormality determining process and the sheet detection process is an example of a processor that implements the image processing method.

### [Belt Abnormality Determining Process]

The image processing portion 8c executes the belt abnormality determining process when the conveying belt 320 is rotating in a non-conveying state in which the sheet 9 is not being conveyed to the conveying belt 320 by the sheet feeding mechanism 30 and the plurality of sets of conveying roller pairs 31.

That is, the image processing portion 8c executes the belt abnormality determining process based on the plurality of line image data LD1 obtained by the line sensor 6 operating when the conveying belt 320 is rotating in the non-conveying state.

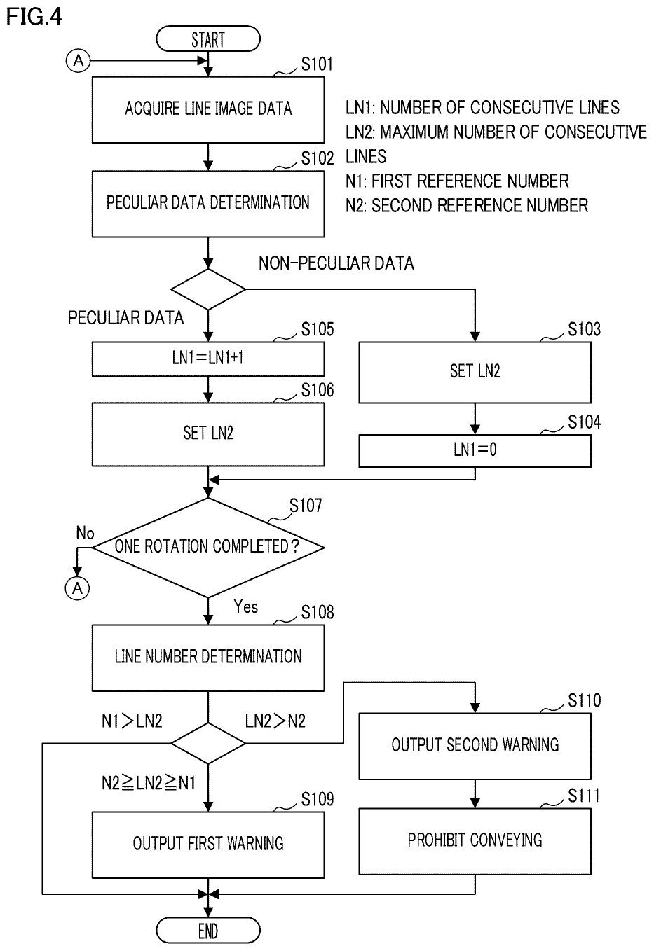

An example of a procedure of the belt abnormality determining process will be described below with reference to the flowchart shown in FIG. 4.

In the following description, S101, S102, . . . represent identification codes of a plurality of steps in the belt abnormality determining process. In the belt abnormality determining process, first, step S101 is executed.

### <Step S101>

In step S101, the image processing portion 8c acquires line image data LD1 for one line obtained by operation of the line sensor 6.

For example, a plurality of line image data LD1 obtained sequentially by the operation of the line sensor 6 are stored in the RAM 81, and the image processing portion 8c acquires one of the plurality of line image data LD1 stored in the RAM 81 in step S101.

After executing the process of step S101, the image processing portion 8c executes the process of step S102.

### <Step S102>

In step S102, the image processing portion 8c executes a unique data determination process to determine whether the line image data LD1 obtained in step S101 is unique data that satisfies a predetermined unique condition or not.

The unique condition is a condition in which the line image data LD1 includes a plurality of unique pixel values that are pixel values that are outside an allowable range, and the number of the plurality of unique pixel values included in the line image data LD1 exceeds a reference pixel number. The pixel values are values of the plurality of pixel data in the line image data LD1.

The allowable range is a range within which the pixel values vary when there is no sheet 9 on the conveying belt 320 and when there are no scratches or stains on the surface of the conveying belt 320 that exceed an allowable limit.

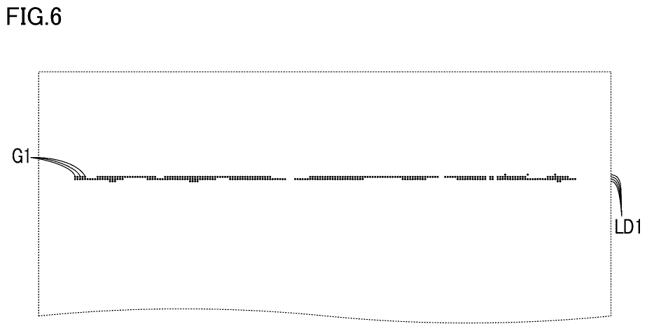

FIG. 6 is a diagram schematically showing a plurality of line image data LD1. In FIG. 6, a plurality of unique pixels G1 in a plurality of line image data LD1 are indicated by black dots. Each of the unique pixels G1 is a pixel having each of the plurality of unique pixel values. In FIG. 6, the horizontal direction is the main scanning direction corresponding to the second direction D2, and the vertical direction is the sub-scanning direction corresponding to the first direction D1.

In the present embodiment, the image processing portion 8c sets the reference pixel number in accordance with sheet size information obtained in advance. The sheet size information is information that indicates a size of the sheet 9 stored in the sheet storing portion 1. For example, the sheet size information is input in advance via the operation device 801 or the communication device 84.

For example, the image processing portion 8c derives the reference pixel number by multiplying a pixel number corresponding to the size of the sheet 9 in the second direction D2, which is indicated by the sheet size information, by a predetermined coefficient.

The image processing portion 8c determines that the line image data LD1 that satisfies the unique condition is the unique data, and determines that the line image data LD1 that does not satisfy the unique condition is non-unique data.

The image processing portion 8c executes the process of step S103 in a case in which it is determined that the line image data LD1 is the non-unique data, and executes the process of step S105 in a case in which it is determined that the line image data LD1 is the unique data.

The image processing portion 8c sets the number of consecutive lines LN1 and the maximum number of consecutive lines LN2 as variables related to the processing of the line image data LD1. The initial values of the number of consecutive lines LN1 and the maximum number of consecutive lines LN2 are zero.

The number of consecutive lines LN1 is a variable that indicates the number of consecutive unique data in a plurality of line image data LD1. The maximum number of consecutive lines LN2 is the maximum value of the number of consecutive lines LN1 for the plurality of line image data LD1 obtained while the conveying belt 320 makes one rotation.

### <Step S103>

In step S103, the image processing portion 8c sets the larger of the number of consecutive lines LN1 and the maximum number of consecutive lines LN2 at the time step S103 is executed as the maximum number of consecutive lines LN2.

That is, in a case in which the number of consecutive lines LN1 is greater than the maximum number of consecutive lines LN2, the image processing portion 8c updates the maximum number of consecutive lines LN2 to the number of consecutive lines LN1, and otherwise maintains the maximum number of consecutive lines LN2.

After executing the process of step S103, the image processing portion 8c executes the process of step S104.

### <Step S104>

In step S104, the image processing portion 8c initializes the number of consecutive lines LN1 to zero. After executing the process of step S104, the image processing portion 8c executes the process of step S107.

### <Step S105>

In step S105, the image processing portion 8c counts up the number of consecutive lines LN1 by one. After executing the process of step S105, the image processing portion 8c executes the process of step S106.

### <Step S106>

In step S106, the image processing portion 8c sets the larger of the number of consecutive lines LN1 and the maximum number of consecutive lines LN2 at the time step S106 is executed as the maximum number of consecutive lines LN2.

That is, in a case in which the number of consecutive lines LN1 is greater than the maximum number of consecutive lines LN2, the image processing portion 8c updates the maximum number of consecutive lines LN2 to the number of consecutive lines LN1, and otherwise maintains the maximum number of consecutive lines LN2.

After executing the process of step S106, the image processing portion 8c executes the process of step S107.

### <Step S107>

In step S107, the image processing portion 8c selects the next process depending on whether or not the processes of steps S101 to S106 have been executed on the plurality of the line image data LD1 obtained while the conveying belt 320 makes at least one rotation, that is, the one-rotation completed state.

In the present embodiment, the detection of reflected light by the line sensor 6 and the output of the line image data LD1 by the signal interface 83 are executed at regular intervals. In this case, the image processing portion 8c recognizes a state in which the number of times the processes of steps S101 to S106 have been performed reaches a predetermined target number of times as the one-rotation completed state.

Note that a rotary encoder (not shown) may be connected to a rotating shaft of one of the plurality of support rollers 321. In this case, the image processing portion 8c may recognize a state in which the number of output pulses of the rotary encoder reaches a target number as the one-rotation completed state.

In a case in which the state in step S107 is not the one-rotation completed state, the image processing portion 8c repeats the process from step S101. On the other hand, in a case in which the state in step S107 is the one-rotation completed state, the image processing portion 8c executes the process of step S108.

### <Step S108>

In step S108, the image processing portion 8c executes a line number determination process for comparing the maximum number of consecutive lines LN2 with each of a plurality of preset reference numbers N1, N2. The image processing portion 8c selects the next process depending on the result of the line number determination process.

In the present embodiment, the plurality of reference numbers N1, N2 include a first reference number N1 and a second reference number N2 that is greater than the first reference number N1.

In a case in which the maximum number of consecutive lines LN2 is smaller than the first reference number N1, the image processing portion 8c determines that the conveying belt 320 is normal, and ends the belt abnormality determining process.

In a case in which the maximum number of consecutive lines LN2 is within a range from the first reference number N1 to the second reference number N2, the image processing portion 8c executes the process of step S109. In a case in which the maximum number of consecutive lines LN2 exceeds the second reference number N2, the image processing portion 8c executes the process of step S110.

### <Step S109>

In step S109, the image processing portion 8c executes a first warning output process to output first warning information indicating that the conveying belt 320 is highly likely to have a slight scratch or stain. For example, the image processing portion 8c outputs the first warning information via one or both of the display device 802 and the communication device 84.

After executing the process of step S109, the image processing portion 8c ends the belt abnormality determining process.

### <Step S110>

In step S110, the image processing portion 8c executes a second warning output process to output second warning information indicating that the conveying belt 320 is highly likely to have a severe scratch or stain. For example, the image processing portion 8c outputs the second warning information via one or both of the display device 802 and the communication device 84.

For example, the second warning information includes information that prompts inspection of the conveying belt 320 and replacement of the conveying belt 320 as necessary. The second warning information may include information indicating that the conveying of the sheet 9 is prohibited until the conveying belt 320 is inspected.

After executing the process of step S110, the image processing portion 8c executes the process of step S111.

### <Step S111>

In step S111, the image processing portion 8c executes a process of prohibiting the sheet conveying device 3 including the first belt conveying device 32 from conveying the sheet 9.

For example, the image processing portion 8c sets a conveying prohibition flag to ON, thereby prohibiting the sheet conveying device 3 from conveying the sheet 9. The printing control portion 8b does not allow the sheet conveying device 3 to convey the sheet 9 when the conveying prohibition flag is set to ON.

For example, when a release command is input via the display device 802 or the communication device 84, the main control portion 8a sets the conveying prohibition flag to OFF. The printing control portion 8b continues to prohibit the conveying of the sheet 9 until the conveying prohibition flag is set to OFF.

Note that setting the conveying prohibition flag to ON and prohibiting the sheet conveying device 3 from conveying the sheet 9 is an example of restricting the conveying of the sheet 9 by the conveying belt 320.

After executing the process of step S111, the image processing portion 8c ends the belt abnormality determining process.

As described above, the image processing portion 8c determines whether each of the plurality of line image data LD1 obtained in the non-conveying state is the unique data or not (see step S102).

More specifically, the image processing portion 8c determines whether each of the plurality of line image data LD1 obtained while the conveying belt 320 rotates at least once in the non-conveying state is the unique data or not (see steps S102 and S107).

Furthermore, the image processing portion 8c determines a degree of abnormality of the conveying belt 320 according to the number of consecutive unique data in the plurality of line image data LD1 obtained in the non-conveying state (see steps S108 to S110).

Note that the second warning output process is executed when a more severe abnormality of the conveying belt 320 is detected than when the first warning output process is executed.

The image processing portion 8c notifies the result of the determination of the degree of abnormality of the conveying belt 320 via one or both of the display device 802 and the communication device 84 (see steps S109 and S110).

The first warning output process and the second warning output process are examples of processes for notifying a result of a determination of the degree of abnormality of the conveying belt 320. The display device 802 and the communication device 84 are each an example of an information output device.

When the determination result of the degree of abnormality of the conveying belt 320 exceeds an upper limit, the image processing portion 8c restricts the conveying of the sheet 9 by the conveying belt 320 (see step S111).

In the present embodiment, the second warning output process is executed when the determination result of the degree of abnormality of the conveying belt 320 exceeds the upper limit. In addition, the process of prohibiting the sheet conveying device 3 from conveying the sheet 9 is an example of a process of restricting the conveying of the sheet 9 by the conveying belt 320.

### [Sheet Detection Process]

The image processing portion 8c executes the sheet detection process when the conveying belt 320 is rotating in a sheet conveying state in which the sheet 9 is conveyed to the conveying belt 320 by the sheet feeding mechanism 30 and the plurality of sets of conveying roller pairs 31.

That is, the image processing portion 8c executes the sheet detection process based on the plurality of line image data LD1 obtained by the operation of the line sensor 6 when the conveying belt 320 is rotating in the sheet conveying state.

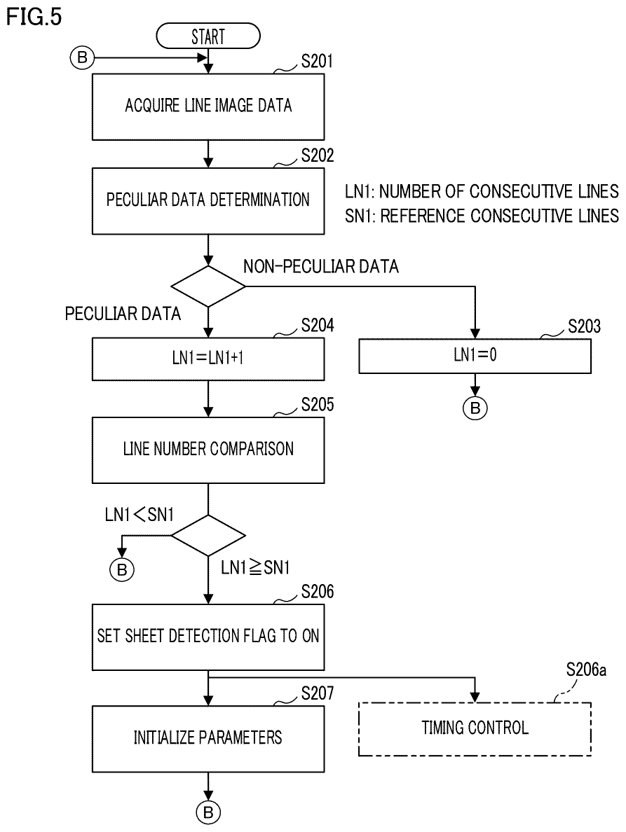

An example of a procedure of the sheet detection process will be described below with reference to the flowchart shown in FIG. 5.

In the following description, S201, S202, . . . represent identification codes of a plurality of steps in the sheet detection process. In the sheet detection process, first, the process of step S201 is executed.

### <Step S201>

In step S201, the image processing portion 8c acquires one line of line image data LD1 obtained by the operation of the line sensor 6, similarly to step S101 in FIG. 4.

After executing the process of step S201, the image processing portion 8c executes the process of step S202.

### <Step S202>

In step S202, the image processing portion 8c executes the unique data determination process on the line image data LD1 obtained in step S201. The process of step S202 is the same as the process of step S102 in FIG. 4.

The image processing portion 8c executes the process of step S203 in a case in which it is determined that the line image data LD1 is the non-unique data, and executes the process of step S204 in a case in which it is determined that the line image data LD1 is the unique data.

### <Step S203>

In step S203, the image processing portion 8c initializes the number of consecutive lines LN1 to zero. After executing the process of step S203, the image processing portion 8c repeats the processes from step S201. Note that in step S203, the image processing portion 8c determines that the sheet 9 has not yet reached the specific position P1.

### <Step S204>

In step S204, the image processing portion 8c counts up the number of consecutive lines LN1 by one. After executing the process of step S204, the image processing portion 8c executes the process of step S205.

### <Step S205>

In step S205, the image processing portion 8c executes a line number comparison process for comparing the number of consecutive lines LN1 with a reference consecutive number SN1. The image processing portion 8c selects the next process depending on the result of the line number comparison process.

The reference consecutive number SN1 is a preset integer of 2 or more. For example, the reference consecutive number SN1 is the number of line image data LD1 corresponding to a length of about 5 to 10 millimeters in the first direction D1. The second reference number N2 used in the belt abnormality determining process is equal to or smaller than the reference consecutive number SN1.

In a case in which the number of consecutive lines LN1 is smaller than the reference consecutive number SN1, the image processing portion 8c determines that the sheet 9 has not yet reached the specific position P1, and repeats the process from step S201.

On the other hand, in a case in which the number of consecutive lines LN1 is equal to or greater than the reference consecutive number SN1, the image processing portion 8c executes the process of step S206.

### <Step S206>

In step S206, the image processing portion 8c determines that the sheet 9 has reached the specific position P1, and sets a sheet detection flag to ON. The initial state of the sheet detection flag is OFF.

The sheet detection flag being set to ON indicates that the arrival of the sheet 9 at the specific position P1 has been detected. The printing control portion 8b controls timing for starting image formation by the printing device 4, starting from a point in time when the sheet detection flag is set to ON (see step S206a in FIG. 5).

After executing the process of step S206, the image processing portion 8c executes the process of step S207.

### <Step S207>

In step S207, the image processing portion 8c initializes parameters related to the sheet detection process.

More specifically, the image processing portion 8c initializes the number of consecutive lines LN1 to zero, and further initializes the sheet detection flag to OFF.

After executing the process of step S207, the image processing portion 8c repeats the processes from step S201. Note that the image processing portion 8c ends the sheet detection process when the printing process is completed.

As described above, the image processing portion 8c determines whether each of the plurality of line image data LD1 obtained in the sheet conveying state is the unique data or not (see step S202).

Furthermore, the image processing portion 8c detects the arrival of the sheet 9 at the specific position P1 when the number of consecutive unique data in the plurality of line image data LD1 obtained in the sheet conveying state reaches a reference consecutive number SN1 (see steps S205 to S206).

Therefore, as long as scratches or stains do not occur over a wide area on the surface of the conveying belt 320, the sheet 9 is distinguished and detected separately from scratches or stains on the surface of the conveying belt 320.

In addition, in a case in which scratches or stains occur over a wide area on the surface of the conveying belt 320, the conveying of the sheet 9 by the conveying belt 320 is restricted by the conveying belt abnormality determining process (see step S111 in FIG. 4). Thus, the sheet 9 is prevented from being erroneously detected due to scratches or stains on the surface of the conveying belt 320.

As described above, by employing the image forming apparatus 10, it is possible to distinguish and detect scratches or stains on the surface of the conveying belt 320 from the sheet 9 on the conveying belt 320.

### SUPPLEMENTARY NOTES

An outline of the invention extracted from the above-described embodiments will be added below. Note that the configurations and processing functions described in the following supplementary notes can be selected and combined as desired.

### <Supplementary Note 1>

An image processing method for processing a plurality of line image data sequentially obtained by a line sensor arranged along a second direction crossing a first direction at a specific position along a conveying belt capable of conveying a sheet along the first direction by rotating;
the image processing method including:
a processor determining whether or not each of the plurality of line image data is unique data including a plurality of unique pixel values that are pixel values outside an allowable range and a number of the plurality of unique pixel values exceeds a reference pixel number; and
the processor detecting that the sheet has reached the specific position when the number of consecutive unique data in the plurality of line image data reaches a reference consecutive number.

### <Supplementary Note 2>

The image processing method according to supplementary note 1, including
the processor determining whether or not each of the plurality of line image data obtained in a non-conveying state in which the sheet is not being conveyed to the conveying belt by a front-stage conveying mechanism arranged on an upstream side of the conveying belt in a sheet conveying direction, is the unique data;
the processor determining a degree of abnormality of the conveying belt according to a number of consecutive unique data in the plurality of line image data obtained in the non-conveying state;
the processor determining whether each of the plurality of line image data obtained in a sheet conveying state in which the sheet is conveyed to the conveying belt by the front-stage conveying mechanism is the unique data or not; and
the processor detecting that the sheet has reached the specific position when the number of consecutive unique data in the plurality of line image data obtained in the sheet conveying state reaches the reference consecutive number.

### <Supplementary Note 3>

The image processing method according to supplementary note 2, including
the processor restricting the conveying of the sheet by the conveying belt when a determination result of the degree of abnormality of the conveying belt exceeds an upper limit.

### <Supplementary Note 4>

The image processing method according to supplementary note 2 or supplementary note 3, including
the processor notifying of the result of the determination of the degree of abnormality of the conveying belt via an information output device.

### <Supplementary Note 5>

The image processing method according to any one of supplementary note 1 to supplementary note 4, including
the processor controlling a start timing of image formation by a printing device that forms an image on the sheet conveyed by the conveying belt in response to a point in time when arrival of the sheet at the specific position is detected.

### <Supplementary Note 6>

An image processing method for processing a plurality of line image data sequentially obtained by a line sensor arranged along a second direction crossing a first direction at a specific position along a conveying belt capable of conveying a sheet along the first direction by rotating;
the image processing method including:
a processor determining whether or not each of the plurality of line image data is unique data including a plurality of unique pixel values that are pixel values outside an allowable range and a number of the plurality of unique pixel values exceeds a reference pixel number; and
the processor determining a degree of abnormality of the conveying belt according to a number of consecutive unique data in the plurality of line image data.

### <Supplementary Note 7>

The image processing method according to supplementary note 6, wherein
the processor determines whether or not each of the plurality of line image data obtained while the conveying belt rotates at least once in a non-conveying state in which the sheet is not being conveyed to the conveying belt by a front-stage conveying mechanism arranged on an upstream side of the conveying belt in the sheet conveying direction, is unique data.

### <Supplementary Note 8>

An image forming apparatus including:
a conveying belt capable of conveying a sheet along a first direction by rotating;
a line sensor arranged along a second direction crossing the first direction at a specific position along the conveying belt;
a printing device configured to form an image on the sheet conveyed by the conveying belt; and
a processor configured to implement an image processing method according to any one of supplementary notes 1 to 7.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An image processing method for processing a plurality of line image data sequentially obtained by a line sensor arranged along a second direction crossing a first direction at a specific position along a conveying belt capable of conveying a sheet along the first direction by rotating;
the image processing method comprising:
a processor determining whether or not each of the plurality of line image data is unique data including a plurality of unique pixel values that are pixel values outside an allowable range and a number of the plurality of unique pixel values exceeds a reference pixel number; and
the processor detecting that the sheet has reached the specific position when the number of consecutive unique data in the plurality of line image data reaches a reference consecutive number.

2. The image processing method according to claim 1, comprising:
the processor determining whether or not each of the plurality of line image data obtained in a non-conveying state in which the sheet is not being conveyed to the conveying belt by a front-stage conveying mechanism arranged on an upstream side of the conveying belt in a sheet conveying direction, is the unique data;
the processor determining a degree of abnormality of the conveying belt according to a number of consecutive unique data in the plurality of line image data obtained in the non-conveying state;
the processor determining whether each of the plurality of line image data obtained in a sheet conveying state in which the sheet is conveyed to the conveying belt by the front-stage conveying mechanism is the unique data or not; and
the processor detecting that the sheet has reached the specific position when the number of consecutive unique data in the plurality of line image data obtained in the sheet conveying state reaches the reference consecutive number.

3. The image processing method according to claim 2, comprising
the processor restricting the conveying of the sheet by the conveying belt when a determination result of the degree of abnormality of the conveying belt exceeds an upper limit.

4. The image processing method according to claim 2, comprising
the processor notifying of the result of the determination of the degree of abnormality of the conveying belt via an information output device.

5. The image processing method according to claim 1, comprising
the processor controlling a start timing of image formation by a printing device that forms an image on the sheet conveyed by the conveying belt in response to a point in time when arrival of the sheet at the specific position is detected.

6. An image processing method for processing a plurality of line image data sequentially obtained by a line sensor arranged along a second direction crossing a first direction at a specific position along a conveying belt capable of conveying a sheet along the first direction by rotating;
the image processing method comprising:
a processor determining whether or not each of the plurality of line image data is unique data including a plurality of unique pixel values that are pixel values outside an allowable range and a number of the plurality of unique pixel values exceeds a reference pixel number; and
the processor determining a degree of abnormality of the conveying belt according to a number of consecutive unique data in the plurality of line image data.

7. The image processing method according to claim 6, wherein
the processor determines whether or not each of the plurality of line image data obtained while the conveying belt rotates at least once in a non-conveying state in which the sheet is not being conveyed to the conveying belt by a front-stage conveying mechanism arranged on an upstream side of the conveying belt in the sheet conveying direction, is unique data.

8. An image forming apparatus comprising:
a conveying belt capable of conveying a sheet along a first direction by rotating;
a line sensor arranged along a second direction crossing the first direction at a specific position along the conveying belt;
a printing device configured to form an image on the sheet conveyed by the conveying belt; and
a processor configured to implement the image processing method according to claim 1.

9. An image forming apparatus comprising:
a conveying belt capable of conveying a sheet along a first direction by rotating;
a line sensor arranged along a second direction crossing the first direction at a specific position along the conveying belt;
a printing device configured to form an image on the sheet conveyed by the conveying belt; and
a processor configured to implement the image processing method according to claim 6.
